(19) United States
(12) Patent Application Publication
(10) Pub. No.: US 2003/0133765 A1
(43) Pub. Date: Jul. 17, 2003

(54) One step countersink

(76) Inventor: Arthur Gerard Capriotti, Vineland, NJ (US)

Correspondence Address: James K. Luchs, 7 Brandon Lane, Sewell, NJ, 08080, US

(21) Appl. No.: 10/042,682

(22) Filed: Jan. 11, 2002

(51) Int. Cl. B23B 51/02

(52) U.S. Cl. 408/224

(57) ABSTRACT

Productivity improves by 30% or more when a single drill bit is used to drill a hole for a threaded metal rod and a countersink hole wherein a metal nut is secured on the rod. Flush wood surfaces are provided for parapet walls and similar structures via one drilling step in comparison with two drilling steps currently being used.

### FIELD OF THE INVENTION

This invention relates to tools for drilling holes in wood. In particular the invention relates to a drill bit that produces countersink holes in one step.

### BACKGROUND OF THE INVENTION

A wide variety of drill bits are known and are available in stores or via special order. U.S. Pat. No. 3,997,279 teaches a drill bit comprising a shank defining an axis and a spade cutter connected to the shank and having cutting edges extending radially of the axis and a lead point extending from the spade cutter. U.S. Pat. No. 5,143,490 teaches a bit for cutting sheet rock: whereas U.S. Pat. No. 5,00,628 teaches a one step square hole drill bit. Many persons have even made tools such as drill bits that satisfied a special need that could not be met with commercially available items or combinations thereof. Yet in spite of a long felt need for a drill bit to drill countersink holes in one operation, there has been no known description of the one step countersink drill bit of the present invention.

### SUMMARY OF THE INVENTION

A drill bit comprising a first spade drill bit to drill a smaller hole than a second spade drill bit to drill a countersink hole in one operation.

A one step countersink drilling device is prepared by welding a smaller radius spade drill bit onto a larger radius spade drill bit. Standard tooling machines can be used to manufacture the device.

An object of the invention is to improve productivity in construction projects such as parapet walls secured with anchor bolts.

### BRIEF DESCRIPTION OF THE DRAWINGS

FIG. 1 An angle view is shown of the one step countersink drill bit as well as wood drilled to allow securing an anchor bolt.

FIG. 2 The two step prior art drills and consecutive holes are illustrated.

### DETAILED DESCRIPTION OF THE INVENTION

Building operations such as parapet walls constantly call for countersink holes in wood for a threaded rod to have a nut tightened in place within the confines of the countersink hole. In this way frames and other structures can be secured with nuts and bolts without any metal extending outside of the wood surfaces.

### DETAILED DESCRIPTION OF THE DRAWINGS

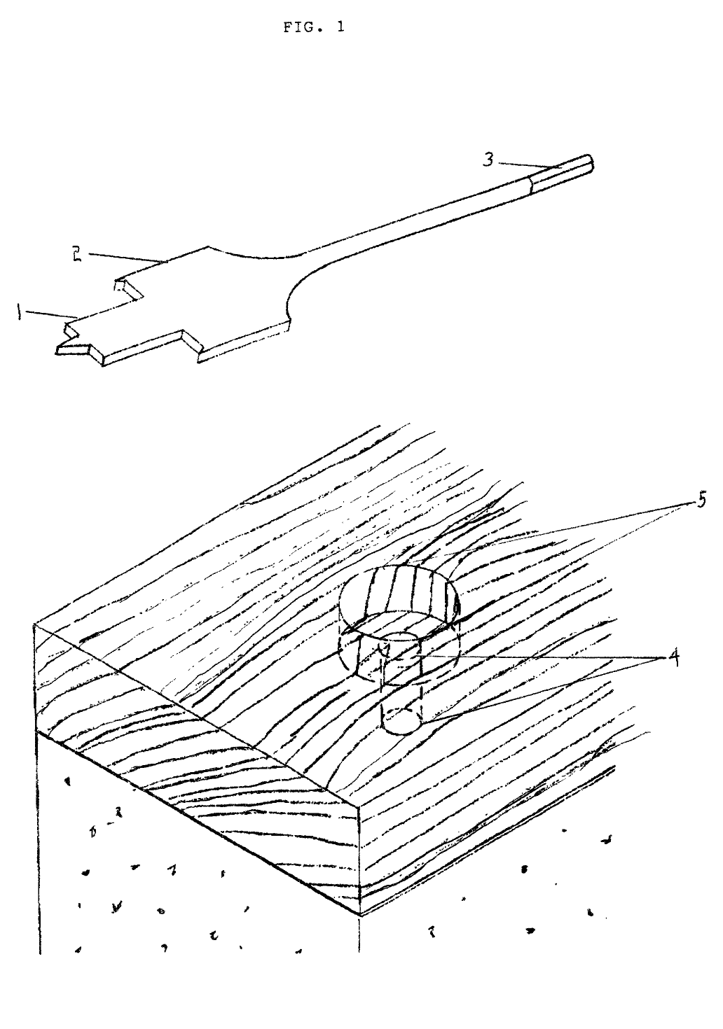

FIG. 1 The one step devices is illustrated with (1) the smaller radius spade bit that drills the central hole, (2) the larger radius spade bit that drills the countersink hole, (3) the flanged surface for fastening the device in a drill chuck. A piece of wood is shown wherein: (4) a central hole drilled with the smaller radius, (5) a countersink hole drilled with the larger radius. A threaded rod through (4) can be secured with a nut within (5) to provide a flush surface.

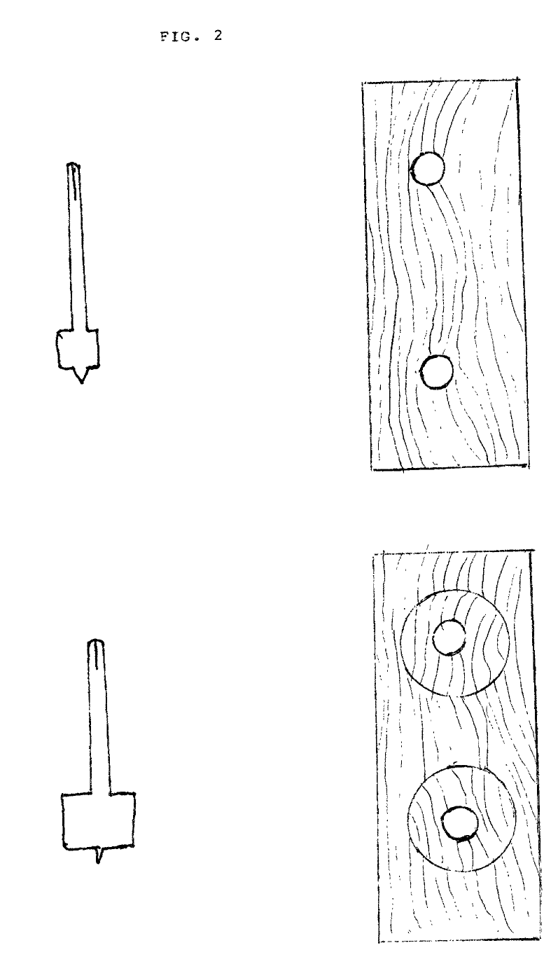

FIG. 2 At the top of the page the first drilling step is shown, whereas the bottom of the page shows how the countersink drill bit finishes the operation. This illustrates the existing state of the art in the building trade prior to the present invention.

The following Examples illustrate the practice of the invention without being limiting. The invention applies to metal reinforced wood frame construction.

### EXAMPLE 1

A combination drill bit as illustrated in FIG. 1 was prepared by welding (1) to (2) such that (3) can be secured in an electric drill. The combination drill bit drilled holes (4) and (5). An anchor bolt embedded in the concrete will extend through (4) such that the wood piece is secured on the concrete via a nut tightened on the anchor bolt within (5) for construction of parapet walls.

### EXAMPLE 2

The combination drill bit as illustrated in FIG. 1 was taken to a construction site and used to drill countersink holes instead of employing the prior art method illustrated in FIG. 2. During a days work it was estimated that an individual construction worker needed to spend only 3.5 hours during the day engaged in this operation compared with 8 hours when two separate drilling operations were required.

What is claimed is:

1. A drill bit comprising a first hole drilling bit furthermost from an end secured in a drill and a second countersink drilling bit adjacent thereto on a common shaft.

2. The drill bit of claim 1 fabricated from metal.

3. The drill bit of claim 2 where the metal is tool grade steel.

4. The drill bit of claim 3 fabricated by welding a hole drilling bit on the end of a countersink drilling bit.

5. The drill bit of claim 3 fabricated with tooling machinery.

6. A spade drill bit consisting of drilling end on a metal shaft, characterized in that a hole drilling bit is located at the end of the shaft and a countersink hole drilling bit of at least twice the drilling radius of the hole drilling bit is located adjacent thereto.

7. The drill bit of claim 6, further characterized in that holes for threaded metal rods and countersink holes for metal nuts to be tightened onto the rods are drilled in one step to allow increased productivity.

8. A method for construction of metal rod reinforced wood frames and parapet walls with the steps:
(1) drilling rod hole and countersink hole using a drill bit secured in a drill,
(2) positioning a threaded rod through the rod hole, and
(3) tightening a nut onto the threaded rod to secure a piece of wood in a frame or wall.

9. The method of claim 8 as shown in FIG. 1.

10. The method of claim 8 providing a productivity increase for an individual worker of at least 30% while engaged in construction of metal reinforced wood frames or structures.
